(19) United States
(12) Patent Application Publication
(10) Pub. No.: US 2007/0177116 A1
(43) Pub. Date: Aug. 2, 2007

(54) METHOD AND APPARATUS FOR MANUFACTURING MICROSTRUCTURE AND DEVICE MANUFACTURED THEREBY

(75) Inventor: Jun AMAKO, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/624,034

(22) Filed: Jan. 17, 2007

(30) Foreign Application Priority Data
Jan. 27, 2006 (JP) 2006-019635

(51) Int. Cl. G03B 27/42

(52) U.S. Cl. 355/53; 359/900; 355/67

(57) ABSTRACT

A method for manufacturing a microstructure, includes: dividing an incident laser beam into a plurality of diffracted beams by means of a diffractive optical element; concentrating said divided plurality of diffracted beams into mutually parallel diffracted beams by means of a telecentric lens; causing each of said mutually parallel diffracted beams to enter perpendicularly to the plane into a collection of axicons comprised of a plurality of axicons arranged into an array in such a manner that the center of each diffracted beam and the center of each axicon coincide, thereby forming a plurality of arrayed Bessel beams; and irradiating said plurality of arrayed Bessel beams onto a machined body.

### BACKGROUND OF THE INVENTION

1. Technical field

The present invention relates to a method and apparatus for manufacturing a microstructure and a device manufactured thereby. Specifically, the invention relates to a method and apparatus for manufacturing a microstructure, which allow formation of desired micro-patterns on the surface or interior of machined bodies with high throughput and high reproducibility. The invention also relates to a device manufactured thereby.

2. Related Art

A Bessel beam has a long focal depth and, therefore, if it is applied to laser machining, high reproducibility can be attained, even if the machining point is displaced in the depth direction due to such a condition that the machined surface is wavy and/or uneven in thickness. It also allows the interior of a thick transparent material to be machined by one operation. Thus, there is increasing interest in the laser micromachining technology using Bessel beams.

Regarding micromachining performed by using Bessel beams, its application to e.g. a process for manufacturing large screens that are used in rear projection TVs, and the like, is being considered.

JP-A-2005-153013 is an example of related art. It proposes a method for machining thin metal films by means of a Bessel beam.

However, conventional machining methods use a single Bessel beam and hence go with low manufacturing throughput. Therefore, they require a large amount of time (from several to several tens of days) when machining a large area. Because of such low throughputs, appropriate use in laser machining applications has not been found for those methods and, thus, dissemination of the machining technique has been hampered.

Theoretically, in order to enhance the throughput, a Bessel beam can be divided into two Bessel beams by means of a polarization beam splitter to perform machining with the two beams.

However, it is difficult to make a polarization beam splitter that allows two Bessel beams to propagate in parallel to each other. Hence, a problem arises in that the machining point is also laterally displaced when it is vertically displaced due to a machined surface that is wavy and/or uneven in thickness, thus hindering maintenance of the machining accuracy.

In addition, division of a Bessel beam by means of a polarization separation element makes two Bessel beams with S polarization and P polarization, respectively, namely each with a different polarization. Thus, consistent machining is hampered, resulting in mutually different shapes, and so on, of machined pores.

### SUMMARY

An advantage of the present invention is to provide a method and apparatus for manufacturing a microstructure, which allow formation of a desired micro-pattern with high throughput and high reproducibility on the surface or interior of a machined body.

It is another advantage of the invention to provide a device that is manufactured by said excellent method for manufacturing a microstructure.

A method for manufacturing a microstructure according to a first aspect of the invention includes: dividing an incident laser beam into a plurality of diffracted beams by means of a diffractive optical element; concentrating said divided plurality of diffracted beams into mutually parallel diffracted beams by means of a telecentric lens; causing said mutually parallel diffracted beams to enter perpendicularly to a collection of axicons, which includes a plurality of axicons arranged in an array in such a manner that the center of each diffracted beam and the center of each axicon coincide, thereby forming a plurality of arrayed Bessel beams; and irradiating said plurality of arrayed Bessel beams onto a machined body.

Preferably, said incident laser beam is a circularly-polarized light.

An apparatus for manufacturing a microstructure according to a second aspect of the invention includes: a diffractive optical element that divides an incident laser beam into a plurality of diffracted beams; a telecentric lens that concentrates said divided plurality of diffracted beams into mutually parallel diffracted beams; and a collection of axicons that includes a plurality of axicons arranged in an array.

Preferably, said axicons are diffractive axicons.

In the invention, a “telecentric lens” is an optical system arranged in such a manner that the principal rays pass through the focal point and go parallel to the optical axis. An “axicon” is an optical system that produces a line image on the optical axis from a point light source having no focal point. A “Bessel beam” is a non-diffracting beam characterized by a long focal depth.

The method for manufacturing a microstructure according to the first aspect of the invention allows formation of a desired micro-pattern on the surface or interior of a machined body with a high throughput and high reproducibility, without being affected by the material and/or the solid state properties of the machined body. According to the method, Bessel beams are very accurately produced in an array to perform machining, so that a plurality of locations can be simultaneously machined by a plurality of Bessel beams having the same state of polarization.

The apparatus for manufacturing a microstructure according to the second aspect of the invention requires no autofocus system, so that the apparatus has a simple configuration and thus can be controlled easily.

### BRIEF DESCRIPTION OF THE DRAWINGS

The invention will be described with reference to the accompanying drawings, wherein like numbers reference like elements.

FIG. 1 shows an apparatus 10 for manufacturing a microstructure according to an embodiment of the invention.

FIG. 2 shows the relief structure of a diffractive optical element 14 used in the embodiment of the invention.

FIG. 3 shows the relief structure of a diffractive axicon 6 used in the embodiment of the invention.

FIG. 4 is part of a photograph showing the exterior of a collection of axicons 16.

FIG. 5A is an SEM image showing a machined hole of a first embodiment and FIG. 5B is a graph showing the average hole size manufactured for different locations of machining point in the first embodiment.

FIG. 6 is a diagram showing a process for manufacturing a metal pattern for a microlens array in a second embodiment.

FIG. 7A is an SEM image of a manufactured mold 43 in the second embodiment and FIG. 7B is an SEM image of a microlens array in the second embodiment.

### DESCRIPTION OF EXEMPLARY EMBODIMENTS

The embodiments of the invention will be described.

The following embodiments are only exemplifications for describing the present invention and are not intended to limit its scope. The invention can be implemented in various forms insofar as they do not depart from the scope and spirit of the invention.

### First Embodiment

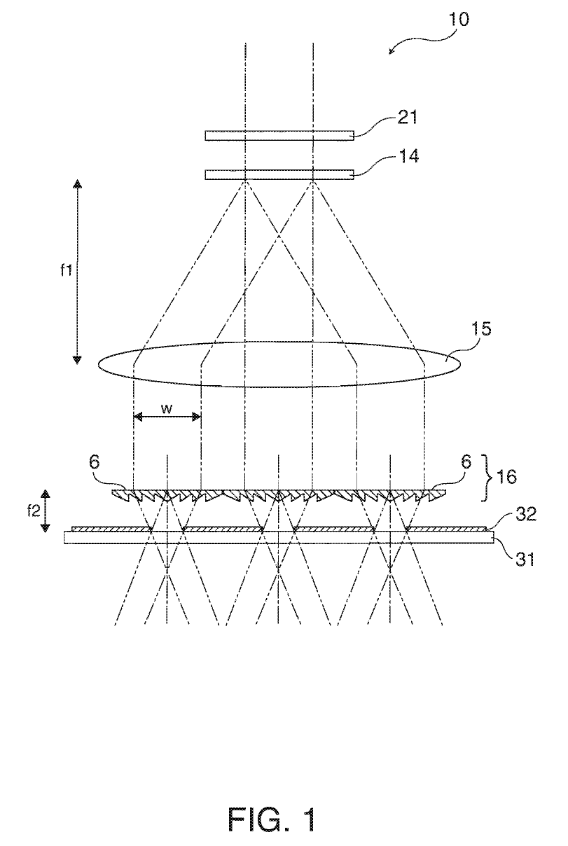

FIG. 1 diagrammatically shows an apparatus 10 for manufacturing a microstructure according to one embodiment of the invention.

As shown in FIG. 1, the apparatus 10 for manufacturing a microstructure includes: a quarter-wave plate 21; a diffractive optical element 14 that divides an incident laser beam into a plurality of diffracted beams; a telecentric lens 15 that concentrates the divided plurality of diffracted beams into mutually parallel diffracted beams; and a collection of axicons 16 that consists of a plurality of diffractive axicons 6 arranged into an array

In the present embodiment, a pulse laser with a pulse length of 10 nsec or less is used for the machining light source. For example, a Q-switch-oscillated Nd:YAG laser having a wavelength of 532 nm, an average power output of 1 W or less (at the pulse repetition of 1 kHz) and a beam diameter of 6 mm φ or less, is used.

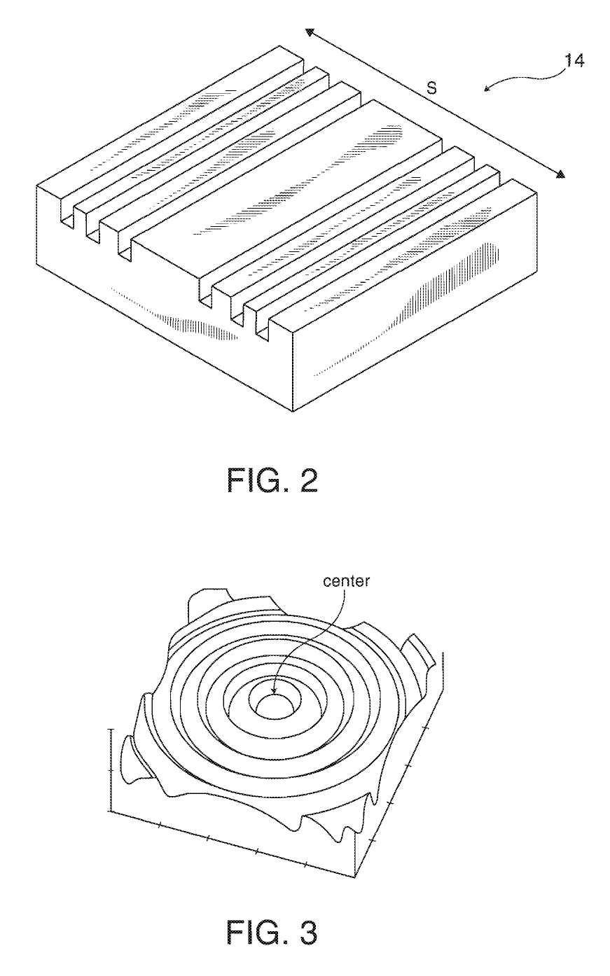

In FIG. 2, the relief structure of the diffractive optical element 14 employed in the embodiment is shown.

The diffractive optical element 14 includes a plurality of binary structures, each of which constituting one period s and having two levels with a predetermined gap, as shown in FIG. 2, so that the surface profile of the element is of a periodic formation. The diffractive optical element 14 is formed on a fused silica substrate by laser lithography and ion etching. The diffractive optical element 14 is not limited to one with a binary structure. For example, it may have a periodic structure which has a sine (cosine) wave-like surface, or a periodic structure which has a flat surface and a periodic refractive index distribution inside.

In FIG. 3, the relief structure of a diffracting axicon 6 employed in the present embodiment is shown.

The diffractive axicon 6 is of a blazed type as shown in FIG. 3, wherein the cycle d is e.g. 5.0 μm and the height h of the relief is 1180 nm. The diffractive axicon 6 is formed on a fused silica substrate by laser lithography and ion etching.

In FIG. 4, part of a photograph displaying the exterior of the complex of axicons 16 is shown, the complex including a plurality of axicons arranged into an array.

In the present invention, the expression “arranged in an array” includes not only the cases where the axicons 6 are arranged in a one-dimensional manner (in a row), as in the present embodiment, but also the cases where the axicons 6 are arranged in a two-dimensional manner (in a matrix).

In addition, embodiments for the arrayed arrangement of the plurality of axicons are not limited to regular arrangements.

### Second Embodiment

As shown in FIG. 1, an incident laser beam is turned into a circularly-polarized light through the quarter-wave plate 21 to be divided into three diffracted beams having a mutually identical strength by the diffractive optical element 14.

Then, the divided three diffracted beams are focused as well as redirected by the telecentric lens 15 to turn into mutually parallel diffracted beams.

Furthermore, the three mutually parallel diffracted beams are caused to enter perpendicular to the complex of axicons 16, which is composed of three diffractive axicons 6 arranged in such a manner that the center of each diffracted beam and the center of each diffracting axicon 6 coincide, each beam being thereby diffracted by each diffractive axicon 6 to form three Bessel beams in line that propagate parallel in the same direction.

Then, by irradiating the generated three arrayed Bessel beams onto a machined body having a Cr film 32 formed on a glass substrate 31, for example, and machining the body, a desired microstructure can be manufactured thereon.

In the apparatus 10 for manufacturing a microstructure, shown in FIG. 1, the spacing Δ between the mutually parallel diffracted beams that are caused to enter into the diffractive axicons 6, is given by the expression: Δ=f1 λ/P, wherein f1 represents the focal length of the telecentric lens 15, λ represents the wavelength of the laser beam and P represents the period of the diffractive optical element 14.

For example, in cases wherein f1=100 mm, λ=532 nm and P=26.6 μm, the spacing Δ between the diffracted beams is 2.0 mm. Therefore, the centers of the diffracted beams and the centers of the axicons can be made to coincide if the diffractive axicons 6 are arranged with the same spacing as Δ to form the complex of axicons 16.

In addition, the width w of the generated Bessel beams is given by the expression: w=0.77 d, wherein d represents the period of the diffractive axicon.

For example, in cases where d=5.0 μm, the width w of the Bessel beams is 3.85 μm.

Furthermore, if the focal depth is defined as a depth that provides 90% or more of the peak intensity, the focal depth of the Bessel beams is as large as 6 mm.

Moreover, in the apparatus 10 for manufacturing a microstructure, shown in FIG. 1, the focal length f1 of the telecentric lens 15 is 100 mm whereas the focal length f2 of the diffracting axicons 6 is 10 mm.

In this way, by being provided with a preferable structure wherein f1 and f2 are in a relationship represented by: f1/f2≧10, Bessel beams having a desired on-axis intensity distribution are formed while being scarcely affected by the wavefront curvature of the beams entering into the diffractive axicons 6.

With reference to FIG. 1, a description has been made of the case where the diffractive optical element 14 divides a beam into three diffracted beams and the collection of axicons 1]6, which includes three diffractive axicons 6 arranged into an array, is used. However, the invention is not limited to such cases, but also allows machining with more number of arrayed Bessel beams (e.g. 13 beams) by increasing the number of division by the diffractive optical element 14 and the number of diffractive axicons 6 included in the complex of axicons 16.

Additionally, the invention is not limited to cases where machining is performed in arranging the diffractive axicons 6 in a one-dimensional manner to obtain a one-dimensionally arrayed Bessel beams. It also allows arranging the diffractive axicons 6 in a two-dimensional manner (in a matrix) and obtaining two-dimensionally arranged Bessel beams to perform machining.

Use of the term “arrayed” is not limited to those having a regular pattern.

In the above embodiment, a description has been made of the case where microholes are formed on the surface of a material that is opaque with respect to the laser wavelength but the invention is also applicable to cases where microstructures are formed in the interior of a material that is transparent with respect to the laser wavelength.

The laser machining method according to the invention allows machining to be performed with a considerably higher throughput than before by employing arrayed Bessel beams.

### FIRST EXAMPLE

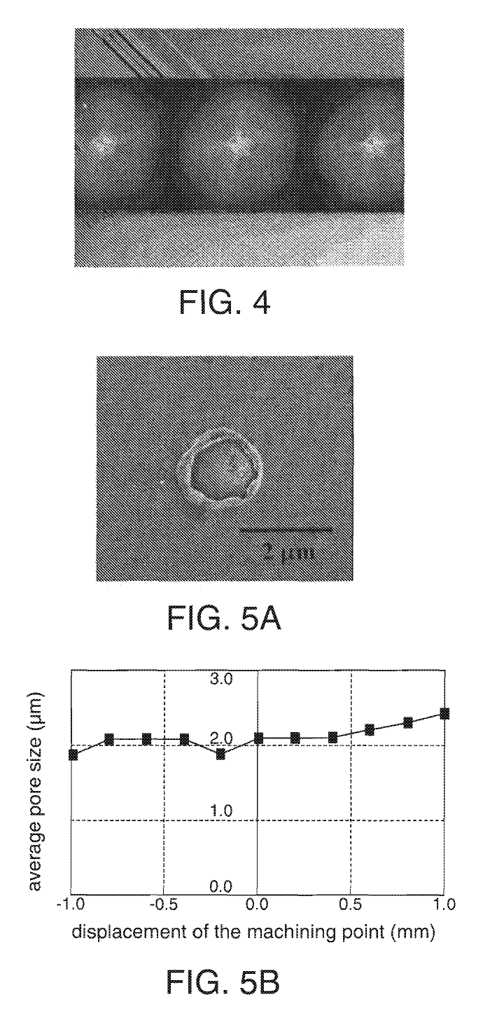

FIGS. 5A and 5B show an example of microholes machined by using the above method for manufacturing a microstructure. FIG. 5A is an SEM image of a microhole with a diameter of 2 μm or less, which has been manufactured by machining with a Bessel beam,. FIG. 5B is a graph showing the average size of a microholes manufactured with respect to different locations (vertical displacement) of a machining point. The machined body in the present embodiment is a Cr film 32 formed on a glass substrate 31, as in the case of the machined body shown in FIG. 1.

As shown in FIG. 5B, it has been found that the Bessel beam is able to drill microholes with a high reproducibility even if the machining point is vertically displaced by ±1 mm or more.

### SECOND EXAMPLE

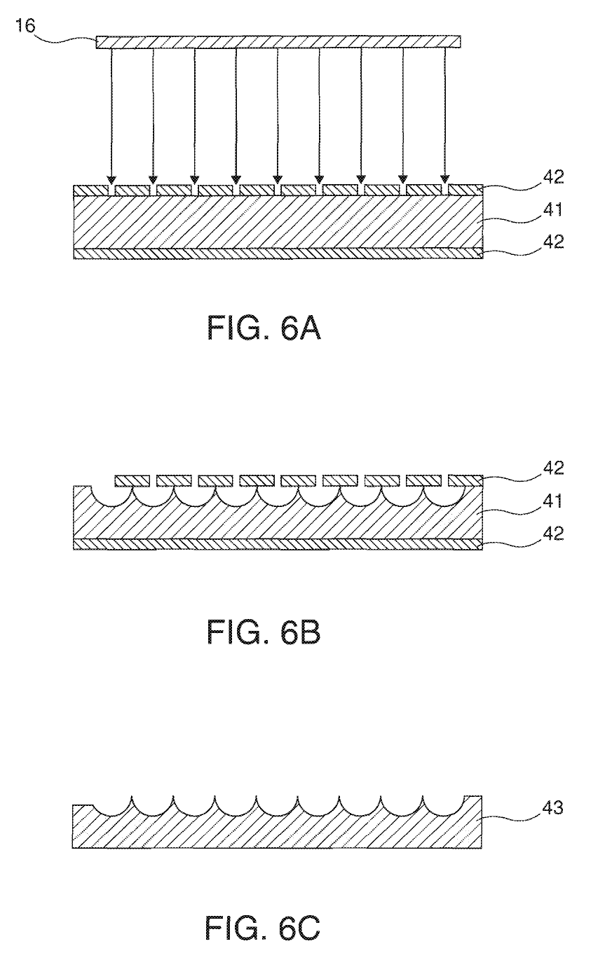

FIGS. 6A, 6B and 6C diagrammatically show the process for manufacturing a metal mold for a microlens array, the process using the above method for manufacturing a microstructure.

First, as shown in FIG. 6A, arrayed microholes were made on a metal film 42 placed on a large-size glass substrate 41 (1 m×1 m or less) using nine Bessel beams arranged into an array Then, as shown in FIG. 6B, chemical etching was used to process the glass substrate 41 through said microholes. Further, by removing the metal film 42, as shown in FIG. 6C, a mold 43 for a lens array was formed on the glass substrate.

A microlens array was molded by means of hot press or 2P method (Photo Polymerization) using the manufactured mold 43.

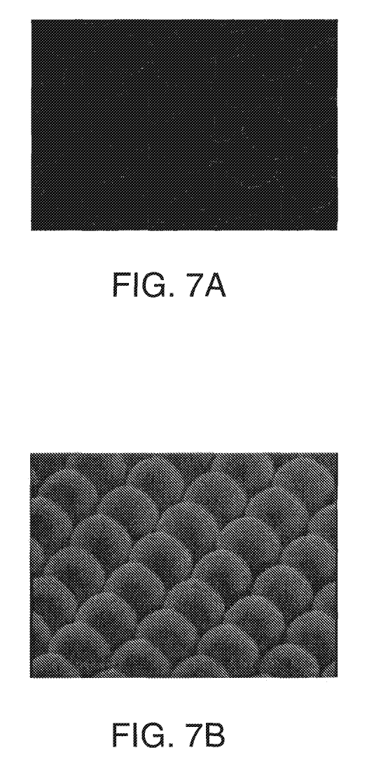

FIG. 7A is an SEM image of the manufactured mold 43, and FIG. 7B is an SEM image of the replicated microlens array.

The surface profile of each lens constituting the manufactured microlens array was spherical while the horizontal and vertical spacing was 72 μm and 54 μm, respectively, and the depth was 76 μm for each lens.

### Applications

The method for manufacturing a microstructure according to the present invention can be used for micromachining such as drilling, cutting, joining, and so on, and is useful for the manufacture of various devices that require formation of microstructure patterns.

For example, the microlens array manufactured by the method for manufacturing a microstructure according to the invention can be applied to large-sized screens used for rear projection TVs, and the like. It can also be applied to a homogenizer (an optical element for flattening the distribution beam irradiation) employed in stepper photolithography machines or liquid-crystal projectors.

In addition, a device manufactured by the method for manufacturing a microstructure according to the invention, wherein micro-fluidic grooves and cavities are formed on and inside glassy substrates, can be applied as a test device used in micro-chemical analysis.

What is claimed is:

1. A method for manufacturing a microstructure, comprising:
dividing an incident laser beam into a plurality of diffracted beams by means of a diffractive optical element;
concentrating the divided plurality of diffracted beams into mutually parallel diffracted beams by means of a telecentric lens;
causing each of the mutually parallel diffracted beams to enter perpendicularly to a collection of axicons comprised of a plurality of axicons arranged in an array in such a manner that the center of each diffracted beam and the center of each axicon coincide, thereby forming a plurality of arrayed Bessel beams; and
irradiating the plurality of arrayed Bessel beams onto a machined body.

2. The method for manufacturing a microstructure according to claim 1, wherein said incident laser beam is a circularly polarized light.

3. An apparatus for manufacturing a microstructure, comprising:
a diffractive optical element that divides an incident laser beam into a plurality of diffracted beams;
a telecentric lens that concentrates the divided plurality of diffracted beams into mutually parallel diffracted beams; and
a collection of axicons comprised of a plurality of axicons arranged into an array.

4. The apparatus for manufacturing a microstructure according to claim 3, wherein the axicons are diffractive axicons.

5. A device manufactured by the method for manufacturing a microstructure according to claim 1.
